(19) United States
(12) Patent Application Publication
(10) Pub. No.: US 2014/0168992 A1
(43) Pub. Date: Jun. 19, 2014

(54) LED LAMP AND LIGHT EFFECT IMPROVING METHOD THEREOF

(71) Applicants: Xinshen Xue, Shenzhen (CN); Youqing Liang, Shenzhen (CN)

(72) Inventors: Xinshen Xue, Shenzhen (CN); Youqing Liang, Shenzhen (CN)

(73) Assignee: CIVILIGHT SHENZHEN SEMICONDUCTOR LIGHTING CO., LTD, Shenzhen (CN)

(21) Appl. No.: 14/236,804

(22) PCT Filed: Aug. 1, 2012
(86) PCT No.: PCT/CN2012/079491

§ 371 Date: Feb. 3, 2014

(30) Foreign Application Priority Data
Aug. 1, 2011 (CN) 201110217999.1

(51) Int. Cl. F21V 13/04; F21K 99/00

(52) U.S. Cl. CPC F21V 13/04; F21K 9/50
USPC 362/307; 313/111

(57) ABSTRACT

A LED lamp and a light effect improving method thereof. A bulb shell (2) is covered on LED beads (3), and is mounted in a reflection cup (1). The bulb shell (2) is used for processing a primary optical process for the light emitted by the LED beads (3). The reflection cup (1) is used for processing a secondary optical process for the light which is subjected to the primary optical process performed by the bulb shell (2). By the functions such as refraction, scattering, diffusion and the like of the bulb shell (2), the primary emergent light emitted from the LED beads (3) is subject to the primary optical process such as mixing, scattering and so on, so as to realize the treatment effect that the light is emitted from the three-dimensional surface of the bulb shell (2). The reflection cup (1) performs the secondary optical process, so as to reflect the scattering light within a certain angle range.

### TECHNICAL FIELD

The present invention relates to semiconductor lighting fields, and more particularly, relates to an LED (Light Emitting Diode) lamp.

### BACKGROUND

Currently, a reflector cup made of, for example, plastic (the surface is treated by plating process), aluminum and the like, or a lens made of transparent PC, PMMA materials is widely used for the optical processing of emitting light in an LED light source and LED lamp. Whether the LED lamp uses the reflector cup or the lens, the gathering efficiency of the light emitted by LED beads is still low, and the light spots reflected by the reflector cup are uneven, and the center light intensity of the spots emitted from the lens is not high. Looking directly at the LED lamps of these two types will produce dazzling effect on the human eye; meanwhile, when the light of a plurality of LEDs is mixed, a separate reflector cup or lens will produce the phenomenon of uneven light mixing and the separation of different colors.

### SUMMARY

The main purpose of the present invention is to provide an LED lamp with superior light effect and the light effect improving method thereof.

So, the present invention provides an LED lamp with improved light effect, comprising: a reflector cup, a bulb shell, an LED bead and a housing, wherein the reflector cup is received into the housing, the LED bead is arranged at the bottom of the reflector cup and is fixed in the housing or at the bottom of the reflector cup, the bulb shell is arranged to cover on the LED bead and located in the reflector cup, the bulb shell is used for a first optical processing of the light emitted by the LED bead, and the reflector cup is used for a second optical processing of the light treated by the bulb shell in the first optical processing.

The present invention further provides a method for improving the light effect of an LED lamp, comprising: a bulb shell is arranged to cover on the LED beads and is located in the reflector cup; use the bulb shell to carry out a first optical processing for the light emitted by the LED beads; use the reflector cup to carry out a second optical processing for the light treated by the bulb shell in the first optical processing.

In the embodiment of the LED lamp, by means of refraction, scattering, diffusion and other effects of the bulb shell, the light emitted from the LED beads is subject to the first optical processing such as light mixing and light scattering and the like to achieve the treatment effect that the light is emitted from the three-dimensional surface of the bulb shell; a reflector cup is used for the second optical processing and it reflects the scattering light in such a way that the scattering light is emitted in a certain range of angles, the light emitted from the LED beads is efficiently mixed and then gathered to improve comfort level and light gathering efficiency of the LED lamps, so that the LED lamp does not glare, the light of the LED lamp is comfortable, the brightness of the LED lamp is enhanced, further, the mixed light is more even.

In the embodiment of the LED lamp, an external main structure of an LED lamp can be consistent with the structure of a conventional lens, which can be directly used for replacement, it is more easily produced and has little effect on the cost.

### BRIEF DESCRIPTION OF THE DRAWINGS

FIG. 1 is a schematic diagram of a combination mode of an LED lamp according to one embodiment of the present invention;

FIG. 2 is a schematic diagram of an assembled LED lamp according to another embodiment of the present invention;

FIG. 3 is the first schematic diagram of a bulb shell according to one embodiment of the present invention;

FIG. 4 is the second schematic diagram of a bulb shell according to one embodiment of the present invention;

FIG. 5 is the third schematic diagram of a bulb shell according to one embodiment of the present invention;

FIG. 6 is the forth schematic diagram of a bulb shell according to one embodiment of the present invention;

FIG. 7 is the fifth schematic diagram of a bulb shell according to one embodiment of the present invention;

FIG. 8 is the sixth schematic diagram of a bulb shell according to one embodiment of the present invention;

FIGS. 9-13 are schematic diagrams of different combination modes of LED beads according to one embodiment of the present invention.

### DETAILED DESCRIPTION OF THE PREFERRED EMBODIMENTS

The embodiments of the present invention will be explained below in detail with reference to the accompanying drawings.

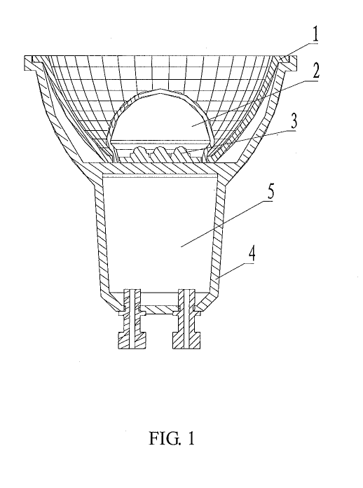

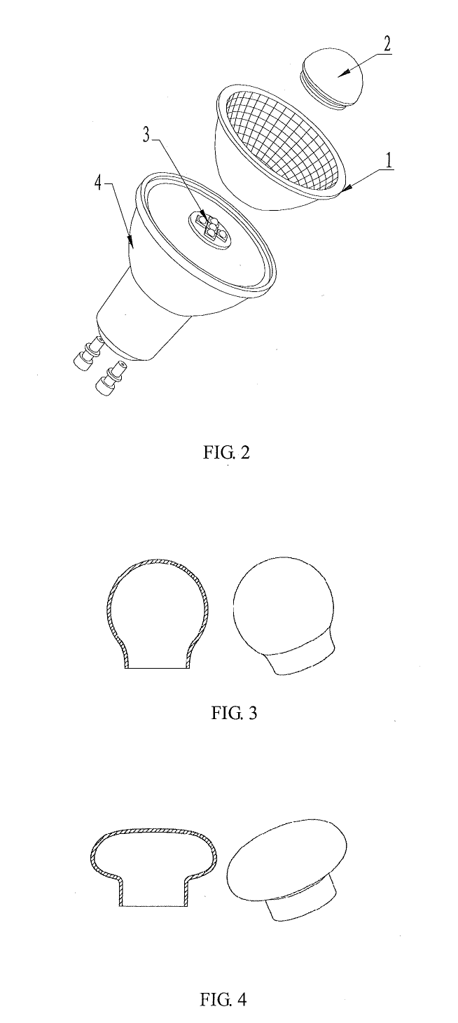

The FIG. 1 and FIG. 2 show schematic implementation diagrams of an LED lamp according to one embodiment of the present invention, comprising: a reflector cup 1, a bulb shell 2, an LED bead 3, a power supply 5 and a housing 4, wherein the LED bead 3 is arranged at the bottom of the reflector cup 1 and is fixed inside the housing, and the LED bead 3 is powered by the power supply 5, the reflector cup 1, the bulb shell 2 and the LED bead 3 are received in the housing 4, and the bulb shell 2 is arranged above the LED beads 3. The light initially emitted from the LED beads is subject to a first optical processing by means of refraction, scattering, and diffusion(diffuse reflection) to achieve the effect that the light is emitted from the three-dimensional surface; the reflector cup accommodates the bulb shell and is used for carrying out a second optical processing for the light from LED beads, the reflector cup 1 reflects and collects the light scattered by the bulb shell 2 so that the reflected light is emitted in a certain range of angles, therefore the light emitted from the LED beads is efficiently mixed and then gathered, which improves the light comfort level and light gathering efficiency of the LED lamp, so that the LED lamp does not glare, the light of the LED lamp is comfortable, the brightness of the LED lamp is enhanced, further, the mixed light is more even. The structure of this LED lamp in this embodiment can be directly applied to existing LED lamp, and can also in conjunction with existing parts structure, such as aluminum plate, a lens, a base, a cover glass (cover) and the like.

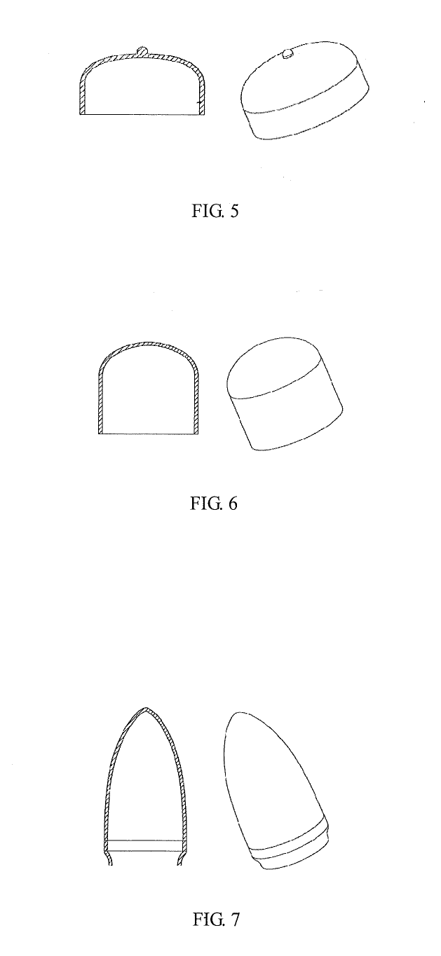

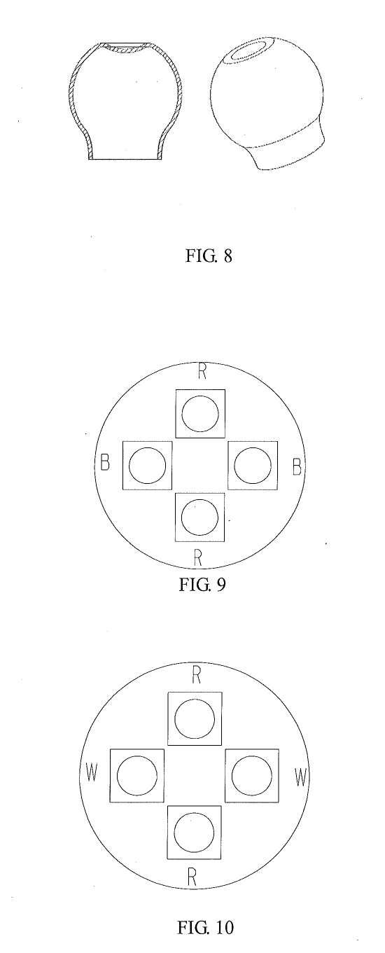

FIG. 3-FIG. 8 show the embodiments of bulb shells, the bulb shell can be designed in various shapes, as long as it can ensure a good light mixing and scattering effect. For example, as shown in FIG. 3, the bulb shell is bulb-shaped; as shown in FIG. 4, the bulb shell is nut-shaped; as shown in FIG. 5, the bulb shell is hat-shaped with a small protrusion at the top; as shown in FIG. 6, the bulb shell is cylindrical with a protrusion at the top; as shown in FIG. 7, the bulb shell is candle-shaped; as shown in FIG. 8, the bulb shell is bulb-shaped with a circular recess at the top. The bulb shell can be treated in different methods, such as glass frosting, powder spraying or silicone spraying etc., and can also be made of PC or PMMA materials with light transmittance of above 80% and below 100%.

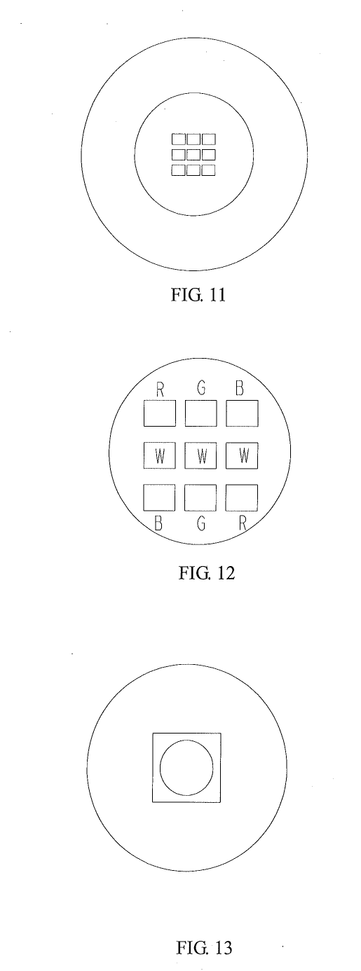

FIG. 9-FIG. 13 show the embodiments of different combinations of the LED chips of the LED beads, comprising: two pieces of red light LED chips +two pieces of blue light LED chips as shown in FIG. 9; two pieces of white light LED chips +two pieces of red light LED chips as shown in FIG. 10; different color combinations as shown in FIG. 11 and FIG. 12; monochromatic LED chip as shown in FIG. 13 and the like. The LED beads can be directly or indirectly placed in the reflector cup or in the housing.

The LED lamp in this embodiment can be applied to spot light, bulb light and other light equipments, and can also be used on cameras, signal (such as laser) transmission and acquisition instruments, so the LED lamp can be used in different environments, and the using range of which is wide.

The present invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

What is claimed is:

1. An LED lamp including: a reflector cup, a bulb shell, an LED bead and a housing; wherein the reflector cup is received into the housing; the LED bead is arranged at the bottom of the reflector cup; the bulb shell is arranged to cover on the LED bead and located in the reflector cup; the bulb shell is used for carrying out a first optical processing for the light emitted by the LED bead, and the reflector cup is used for carrying out a second optical processing for the treated light by the bulb shell in the first optical processing.

2. The LED lamp as claimed in claim 1, wherein the first optical processing is to perform light mixing and scattering for the light emitted by the LED bead.

3. The LED lamp as claimed in claim 2, wherein the second optical processing is to reflect the treated light in the first optical processing on the inner wall of the reflector cup and control the light spot and light angle.

4. The LED lamp as claimed in claim 3, wherein the LED bead comprises at least one LED chip, and the LED chip is one or more selected from the group consisting of red, orange, yellow, green, cyan, blue, purple and white light LED chips.

5. The LED lamp as claimed in claim 3, wherein the bulb shell is made of a light transmitting material with light transmittance of greater than or equal to 80% and less than 100%.

6. The LED lamp as claimed in claim 3, wherein the bulb shell includes a frosted glass shell; or the bulb shell includes a glass shell, the surface of the glass shell has a sprayed layer or adhesive layer for diffuse reflection of a light.

7. The LED lamp as claimed in claim 3, wherein the inner wall of the reflector cup has a reflective surface with an optical effect or for decoration.

8. The LED lamp as claimed in claim 3, wherein the bulb shell has a shape for scattering the light on the surface, and the shape is selected from the group consisting of hemispherical shape, half pear shape, cylindrical shape, hat shape, bulb shape, screw cap shape, flame shape and candle shape.

9. A method for improving the light effect of an LED lamp, comprising:
a bulb shell is arranged to cover on LED beads and is located in a reflector cup;
use the bulb shell to carry out a first optical processing for the light emitted by the LED beads;
use the reflector cup to carry out a second optical processing for the treated light in the first optical process by the bulb shell.

10. The method as claimed in the claim 9, wherein the first optical processing is to perform light mixing and scattering for the light emitted by the LED beads.
